(19) United States
(12) Patent Application Publication
(10) Pub. No.: US 2026/0141331 A1
(43) Pub. Date: May 21, 2026

(54) SYSTEM AND METHOD FOR IMPLEMENTING AN END-TO-END GENERATIVE AI WORKFORCE TRANSFORMATION PLATFORM

(71) Applicant: KPMG LLP, New York, NY (US)

(72) Inventors: Anu Puvvada, Houston, TX (US); John Doel, West Linn, OR (US); Jonathan Tompary, Arlington Heights, IL (US); Andrew Urban, Seattle, WA (US)

(21) Appl. No.: 19/396,990

(22) Filed: Nov. 21, 2025

Related U.S. Application Data
(60) Provisional application No. 63/723,425, filed on Nov. 21, 2024.

(51) Int. Cl. G06Q 10/0637; G06Q 50/20

(52) U.S. Cl. CPC G06Q 10/06375; G06Q 50/2057

(57) ABSTRACT

The invention relates to computer-implemented systems and methods for providing an end-to-end GenAI workforce transformation platform. An embodiment of the present invention provides an AI guide through an adoption experience for employers and employees to make an impact on new ways of working that change how employers deliver new value while creating a way for employees to own and be valued for their own career. For employers, the innovative platform surfaces the gaps to adoption for employees, helps discover new automation and augmentation opportunities, and puts a strategic plan in place to upskill and reskill today's workforce for an AI-enabled future. The platform empowers employees with ownership of their future, provides a career coach that aligns with their core motivations, facilitates secure, shareable proof of their competencies for career advancement, and provides a strategic blueprint to adopt AI in their roles.

### CROSS REFERENCE TO RELATED APPLICATIONS

The application claims priority to U.S. Provisional Application 63/723,425 (Attorney Docket No. 055089.0000130), filed Nov. 21, 2025, the contents of which are incorporated by reference herein in their entirety.

The application is related to U.S. application Ser. No. 18/368,054 (Attorney Docket No. 055089.0000115), filed Sep. 14, 2023, which claims priority to U.S. Provisional Application No. 63/406,523 (Attorney Docket No. 055089.0000087), filed Sep. 14, 2022, the contents of which are incorporated by reference herein in their entirety.

### FIELD OF THE INVENTION

The present invention relates to systems and methods for implementing an end-to-end Generative Artificial Intelligence (GenAI) workforce transformation platform, and more particularly to a workforce transformation platform that analyzes workforce tasks for AI automation and augmentation opportunities while generating personalized career development pathways and skills management for employees.

### BACKGROUND

The accelerating pace of AI is rapidly making some workforce skills obsolete, leaving companies unprepared for the future. Businesses must urgently reskill employees at speed and scale before the skills gap widens into a crisis, leaving them unable to compete. AI-enabled tools and interfaces change the way many work, from creating content and coding to helping employees think, communicate and collaborate with each other. This type of change does not occur in an instant and getting there is an adoption and experience challenge.

Traditional workforce planning approaches often rely on broad occupational categories and generalized skill assessments that may not capture the nuanced ways AI technologies can impact specific job tasks and activities. Many existing systems focus on high-level job classifications without providing the granular analysis needed to identify which particular work activities within a role are suitable for automation or augmentation. This limitation makes it difficult for organizations to develop targeted strategies for AI adoption and workforce development.

Current career development platforms typically operate independently from AI impact analysis, creating disconnected experiences for employees who must navigate both technological change and career advancement simultaneously. Employees often lack visibility into how emerging AI tools might affect their daily work activities or how they can develop skills to work effectively alongside AI systems. This disconnect between AI adoption planning and individual career development can lead to inefficiencies and missed opportunities for both organizations and their workforce.

Skills taxonomies and occupational databases often lack the dynamic updating mechanisms needed to keep pace with rapidly evolving AI capabilities and their workplace applications. Many organizations struggle to translate standardized occupational information into actionable insights about their specific workforce composition and AI readiness. The challenge is compounded by the need to assess not just whether tasks can be automated, but also how human-AI collaboration might enhance productivity in various work contexts.

Existing workforce analytics tools fall short in delivering personalized recommendations for individual employees or specific guidance on AI tool selection and implementation. The gap between organizational-level workforce planning and individual-level career development creates missed opportunities for both strategic workforce transformation and employee engagement in the AI adoption process.

It would be desirable, therefore, to have a system and method that could overcome the foregoing disadvantages of known systems.

### SUMMARY

According to an embodiment, the invention relates to a computer-implemented system for implementing a workforce transformation and AI-enabled skill development platform. The system comprises: a workforce transformation platform configured to receive workforce data from at least one client organization, wherein the workforce data comprises job titles, job descriptions and task information for employees within the at least one client organization; a workforce shaping subsystem configured to analyze the workforce data by decomposing the job descriptions into constituent tasks and aligning the tasks with a skills ontology that categorizes work activities according to their suitability for artificial intelligence automation or augmentation, and to classify each task based on a set of factors comprising repeatability, data utilization requirements, human collaboration needs and specialized knowledge requirements; a workforce optimization subsystem configured to generate personalized career development pathways for individual employees based on AI impact analysis of their current roles and identified skill gaps; and a digital skills wallet configured to store and manage employee credentials, achievements, and verified competencies in a portable format; wherein the platform is configured to generate an AI opportunity scorecard that identifies roles, tasks, and organizational areas with an optimal potential for AI-driven productivity improvements, and to calculate monetary values associated with potential time savings and productivity gains from AI implementation.

According to another embodiment, the invention relates to a computer-implemented method for workforce transformation and AI-enabled skill development. The method comprises the steps of: receiving, via a workforce transformation platform, workforce data from at least one client organization, wherein the workforce data comprises job titles, job descriptions and task information for employees within the at least one client organization; analyzing, via a workforce shaping subsystem, the workforce data by decomposing the job descriptions into constituent tasks and aligning the tasks with a skills ontology that categorizes work activities according to their suitability for artificial intelligence automation or augmentation, and to classify each task based on a set of factors comprising repeatability, data utilization requirements, human collaboration needs and specialized knowledge requirements; generating, via a workforce optimization subsystem, personalized career development pathways for individual employees based on AI impact analysis of their current roles and identified skill gaps; storing and managing, via a digital skills wallet, employee credentials, achievements, and verified competencies in a portable format; and generating an AI opportunity scorecard that identifies roles, tasks, and organizational areas with an optimal potential for AI-driven productivity improvements, and to calculate monetary values associated with potential time savings and productivity gains from AI implementation.

The invention also relates to a method and a computer-readable medium containing program instructions for executing a method for implementing a workforce transformation platform.

An embodiment of the present invention recognizes that AI-human collaboration is at the core of workforce transformation where workforces may be re-engineered to shape how and when humans work with AI, how activities will be impacted and how individuals discover new opportunities as traditional activities evolve. By unlocking their potential and helping them understand how generative AI impacts their day-to-day role, employees gain better control of their careers and drive new and better experiences at the company. An embodiment of the present invention is directed to identifying the areas most impacted by AI at the company and individual level, migrating employees to an AI-centric world and helping them hone their abilities to collaborate with AI through pathways that realize value for the business and the employee.

These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary system platform architecture, according to an embodiment of the present invention.

FIG. 2 is an exemplary flow diagram, according to an embodiment of the present invention.

FIG. 3 is an exemplary flow diagram, according to an embodiment of the present invention.

FIG. 4 is an exemplary illustration of an AI model, according to an embodiment of the present invention.

FIG. 5 is an exemplary flow diagram, according to an embodiment of the present invention.

FIG. 6 is an exemplary user interface, according to an embodiment of the present invention.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

An embodiment of the present invention provides a comprehensive computer-implemented system and method for workforce transformation and AI-enabled skill development that addresses the challenges organizations face when integrating artificial intelligence technologies into their operations. An embodiment of the present invention is directed to a Generative AI (“GenAI”) workforce transformation platform that receives workforce data from client organizations and utilizes a set of interconnected subsystems to analyze job descriptions, decompose them into constituent tasks and strategically align these tasks with a skills ontology that categorizes work activities according to their suitability for AI automation or augmentation. A workforce shaping subsystem classifies tasks based on factors such as repeatability, data utilization requirements, human collaboration needs and specialized knowledge requirements, while a workforce optimization subsystem generates personalized career development pathways for individual employees based on AI impact analysis and identified skill gaps.

An embodiment of the present invention incorporates advanced features including a digital skills wallet that stores and manages employee credentials in a portable format, an AI tool recommendation engine that matches specific tasks with appropriate AI technologies, and real-time coaching capabilities that provide contextual recommendations during task execution. The platform may generate comprehensive AI opportunity scorecards that identify roles, tasks and organizational areas with the highest potential for AI-driven productivity improvements, calculating monetary values associated with potential time savings and productivity gains. An embodiment of the present invention may utilize machine learning algorithms to continuously update AI impact assessments, integrate with third-party human resources systems and provide feedback mechanisms that capture employee interactions with AI tools to refine future recommendations and improve accuracy of productivity calculations.

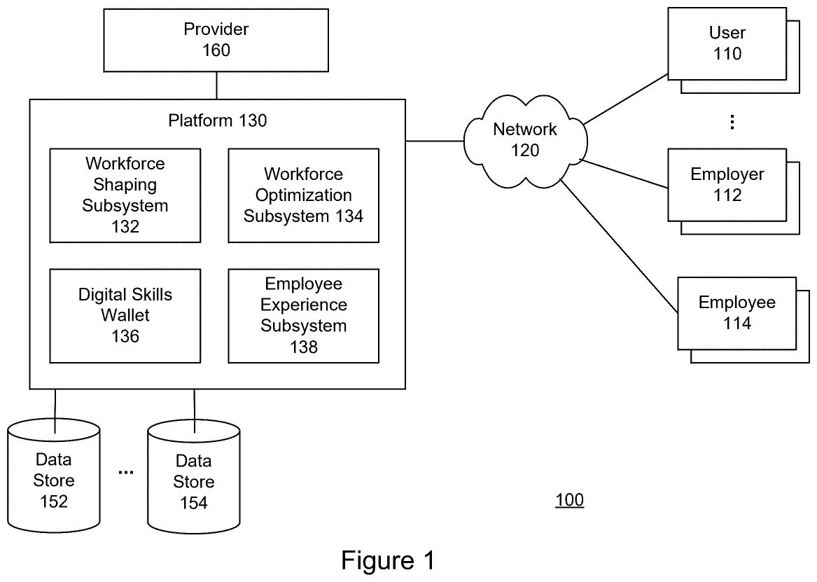

FIG. 1 is an exemplary system platform architecture, according to an embodiment of the present invention. An embodiment of the present invention is directed to a connected platform and service to deliver on augmented workforces.

Companies are in the process of adopting AI solutions which will change the way people work. Most employees do not currently have the skills to adjust/adopt at the speed in which technology is evolving. An embodiment of the present invention is directed to assisting companies understand where opportunities lie within the organization and how to match employee skills to augment individual roles with GenAI. An embodiment of the present invention further supports and identifies how best to integrate and determine where augmented employees have the highest value. An embodiment of the present invention also predicts what skills/experience will be needed to support evolving technology and how to train current employees to work towards those technologies and enhancements. An embodiment of the present invention further assists employees in implementing GenAI to realize meaningful change and efficiencies within the organization. An embodiment of the present invention enables companies to understand where opportunities are within the organization and how the skills/tasks are going to change as well as how to transform these roles over time and shape them.

Employees may be provided a roadmap solution that facilitates integration with GenAI solutions directly into their flow of work at the employee level. This may involve a plan with specific recommendations and guidance on how to perform a task or action in real-time during course of work.

An embodiment of the present invention is directed to a task level analysis that translates roles into tasks/work activities. An embodiment of the present invention may then identify tasks/activities that will most benefit from AI through augmentation and/or automation. For example, the system may identify the roles/teams that will be most impacted or derive the most benefit. Employees/teams may be identified for transformation adoption.

An embodiment of the present invention is directed to understanding/ascertaining the skills that people have. As employees learn new skills through GenAI or other AI tools, an embodiment of the present invention may then capture the updated skills. An embodiment of the present invention is directed to understanding what employees are working on and providing real-time on the job tasks to make their work more efficient through GenAI or other AI tools/services. This enables employees to be fully augmented with AI technology.

An embodiment of the present invention provides employee awareness and clear real-time guidance on how to incorporate and fully utilize GenAI tools into the employee's tasks. An embodiment of the present invention is aware of the employees workload and knows when there are inefficiencies and provide personalized and specific guidance to realize the full potential and features of the GenAI tool for the particular task and role. An embodiment of the present invention provides timely information during the flow of work and while the employee is performing their work. While the primary use case is GenAI, an embodiment of the present invention may be applied to any technology that impacts the workforce at scale.

As shown in FIG. 1, Network 120 may be communicatively coupled to user devices, represented by 110. Other systems may be supported including other users, teams via various computing devices. As shown in FIG. 1, Employers 112 and Employees 114 may access Platform 130 through Network 120. Computing devices may include computers, laptops, workstations, kiosks, terminals, tablets, mobile devices, mobile phones, smart devices, etc.

Network 120 communicates with Platform 130 to deliver augmented workforces. Platform 130 may include Workforce Shaping Subsystem 132, Workforce Optimization Subsystem 134, Digital Skills Wallet 136 and Employee Experience Subsystem 138. Employers may interact with Workface Shaping Subsystem 132 and Workforce Optimization Subsystem 134. Employees may interact with Digital Skills Wallet 136 and Employee Experience Subsystem 138. Other functions and services may include Workforce Engineering Services and AI Transformation. Workforce Engineering Services may include a science-based center of excellence (COE) for adoption, skills-based workforces, workforce planning, change management and culture. AI Transformation may include technology transformation services and pass-through business.

Workforce Shaping Subsystem 132 provides an integrated approach that assesses AI's impact on roles, identifies automation and augmentation opportunities, and recommends strategies for upskilling. Workforce Shaping Subsystem 132 may generate AI components including AI Opportunity Scorecard, AI Roles and AI Transformation Hub. AI Opportunity Scorecard identifies the most impacted roles, skills, businesses and the recommended technology for a use case. Workforce Shaping Subsystem 132 provides a comprehensive overview of the roles and departments that may benefit the most from adopting AI. AI Roles helps reshape and optimize roles for augmented workforces. AI Transformation Hub provides workforce skills gap analytics, adoption and integration analytics, opportunities for automation and augmentation. AI Transformation Hub provides an integrated approach to understanding the workforce to identify opportunities for automation and augmentation. Workforce Shaping Subsystem 132 empowers an organization to adopt generative AI with a recommended strategic roadmap.

Workforce Optimization Subsystem 134 ensures employees'skills and aspirations are matched with suitable upskilling opportunities and critical experience moments for professional advancement. Workforce Optimization Subsystem 134 provides experience recommendations to identify new opportunities to fill skills gaps and use new AI skills and personalized AI-centric career development paths that ensure an employee's skills and aspirations are matched with suitable opportunities.

Digital Skills Wallet 136 empowers employees with ownership of their future and alignment with their core motivations, and further facilitates secure, shareable proof of their competencies for career advancement. Digital Skills Wallet 136 provides a holistic view of the employee's professional journey; captures pivotal achievements and career moments and provides digital identity-based verified digital credentials for skills and experiences for portability. Additional details relating to Digital Skills Wallet may be found in co-pending U.S. application Ser. No. 18/368,054, filed Sep. 14, 2023, which claims priority to U.S. Provisional Application No. 63/406,523, filed Sep. 14, 2022, the contents of which are incorporated by reference herein in their entirety.

With an embodiment of the present invention, digital assets may be represented as secured credentials. An embodiment of the present invention seeks to reshape the workforce by identifying skills needed, tasks that are performed and reorganization of teams. This impacts and accelerates career pathways and recruiting may be more intentional and efficient through internal mobility.

An embodiment of the present invention is directed to implementing digital credentials based on a standard, such as W3C standard, that other entities follow, e.g., universities, etc. The digital credentials may represent a random set of characters tied to an underlying digital certification which may be stored on-chain or off-chain. This enables an issuing company to determine what to expose and what not to expose while still being tied to a specific digital wallet.

For example, a digital certificate may identify skills that have been achieved and how those skills have been demonstrated. An employer may redact client information and other sensitive data. In this example, delivery may occur through the digital wallet.

With Employee Experience Subsystem 138, employees may receive a digital skill blueprint to adopt AI in their roles and continuous learning available at the right time and place to evolve with the rapid pace of the technology. Employee Experience Subsystem 138 provides AI-powered learning plans to gain confidence and accelerate adoption of AI; career advice and mentorship through AI-powered coaching; and career roadmaps with visual guides for career progression with AI-integrated milestones.

Employee Experience Subsystem 138 may provide employee augmentation through AI-Human Collaboration; AI-powered Coaching and Career Roadmaps. AI-Human Collaboration delivers AI learning at the moment of the task to accelerate the impact of AI for the organization and employee. AI-powered Coaching provides a personalized career coach that guides and mentors the employee. Career Roadmaps provide visual guides for career progression with new AI skills

An embodiment of the present invention is directed to outcome-driven AI investments. An exemplary workflow may include an employee who initiates a process to help her augment her job with AI. Here, an AI impact algorithm may be applied at the organization and role level. The employee may receive an AI-human collaboration plan and career map. An embodiment of the present invention may send the employee tips on how to use AI in impacted areas of her job. Through her AI transformation program, the employee engages and uses AI in some of her work. The employee may collaborate with the AI to take on 20% of her tasks. She now has 20% of her time free to take on other skills. A skills ontology may be applied across activities and AI opportunities. An embodiment of the present invention may recommend new experiences to the employee to help upskill while aligning to her career aspirations. An embodiment of the present invention may apply experience-driven upskill and reskill methodology. The employee is now working in different areas adjacent to her skillset and bringing value to more teams in the organization. An embodiment of the present invention may implement a recommendation engine for experiences/skills. The organization's key performance indicators (KPIs) are met and C-suite is confident with investments made in AI and their people. An embodiment of the present invention may provide opportunity analysis and measurement. Others uses, scenarios and integrations may be supported.

The system components are exemplary and illustrative, Platform 130 may interact with additional modules, a combination of the modules described and/or less modules than illustrated. While a single illustrative block, module or component is shown, these illustrative blocks, modules or components may be multiplied for various applications or different application environments. In addition, the modules or components may be further combined into a consolidated unit. The modules and/or components may be further duplicated, combined and/or separated across multiple systems at local and/or remote locations. Other architectures may be realized.

Platform 130 may be communicatively coupled to data storage devices represented by Data stores 152, 154. Data stores 152, 154 may also store and maintain source code, reports, performance data, historical data, etc. The workforce transformation features described herein may be provided by Platform 130 and/or a third party provider, represented by 160, where Provider 160 may operate with Platform 130.

The system 100 of FIG. 1 may be implemented in a variety of ways. Architecture within system 100 may be implemented as hardware components (e.g., module) within one or more network elements. It should also be appreciated that architecture within system 100 may be implemented in computer executable software (e.g., on a tangible, non-transitory computer-readable medium) located within one or more network elements. Module functionality of architecture within system 100 may be located on a single device or distributed across a plurality of devices including one or more centralized servers and one or more mobile units or end user devices. The architecture depicted in system 100 is meant to be exemplary and non-limiting. For example, while connections and relationships between the elements of system 100 is depicted, it should be appreciated that other connections and relationships are possible. The system 100 described below may be used to implement the various methods herein, by way of example. Various elements of the system 100 may be referenced in explaining the exemplary methods described herein.

Network 120 may be a wireless network, a wired network or any combination of wireless network and wired network. Network 120 may further include one, or any number of the exemplary types of networks operating as a stand-alone network or in cooperation with each other. Network 120 may utilize one or more protocols of one or more network elements to which it is communicatively coupled. Network 120 may translate to or from other protocols to one or more protocols of network devices. Although Network 120 may be depicted as one network for simplicity, it should be appreciated that according to one or more embodiments, Network 120 may comprise a plurality of interconnected networks, such as, for example, a service provider network, the Internet, a cellular network, corporate networks, or even home networks, or any of the types of networks mentioned above.

Data may be transmitted and received via Network 120 utilizing a standard networking protocol or a standard telecommunications protocol. For example, data may be transmitted using protocols and systems suitable for transmitting and receiving data. Data may be transmitted and received wirelessly or in some cases may utilize cabled network or telecom connections or other wired network connection.

While FIG. 1 illustrates individual devices or components, it should be appreciated that there may be several of such devices to carry out the various exemplary embodiments. Platform 130 may communicate using any mobile or computing device, such as a laptop computer, a personal digital assistant, a smartphone, a smartwatch, smart glasses, other wearables or other computing devices capable of sending or receiving network signals. Computing devices may have an application installed that is associated with Platform 130.

Platform 130 may be communicatively coupled to Data Stores 152, 154 as well as remote storages. These storage components may include any suitable data structure to maintain the information and allow access and retrieval of the information. The storage may be local, remote, or a combination. The storage components may have back-up capability built-in. Communications with the storage components may be over a network, such as Network 120 or communications may involve a direct connection between the various storage components and Provider 160, as depicted in FIG. 1. The storage components may also represent cloud or other network based storage.

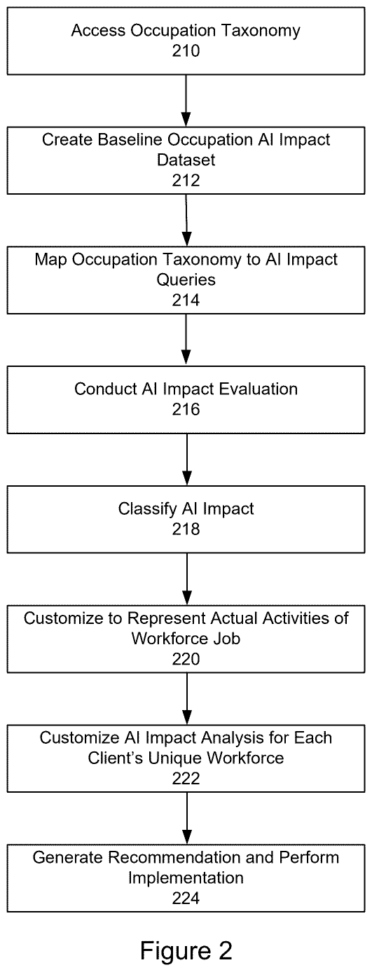

FIG. 2 is an exemplary flow diagram, according to an embodiment of the present invention. At step 210, an occupation taxonomy may be accessed. At step 212, a baseline occupation AI impact dataset may be created. At step 214, the occupation taxonomy may be mapped to a set of AI impact queries. At step 216, an AI impact evaluation may be conducted. At step 218, a classification of AI impact may be applied. At step 220, an output may be customized to represent actual activities of a client workforce job. At step 222, AI impact analysis may be customized for each client's unique workforce. At step 224, a recommendation may be generated and then implemented. While the process of FIG. 2 illustrates certain steps performed in a particular order, it should be understood that the embodiments of the present invention may be practiced by adding one or more steps to the processes, omitting steps within the processes and/or altering the order in which one or more steps are performed. Additional details for each step are provided below.

At step 210, an occupation taxonomy may be accessed. The occupation taxonomy may represent a taxonomy linked to functional roles and business value factors. For example, the occupation taxonomy may include standardized occupational classifications from sources such as Occupational Information Network (ONET), which may provide detailed task descriptions, skill requirements and work activities for various occupations.

At step 212, a baseline occupation AI impact dataset may be created. The baseline dataset may establish standardized AI impact scores for occupational tasks and activities, providing a foundation for subsequent customization and analysis. In some cases, the baseline dataset may incorporate impact classifications that categorize tasks based on their potential for automation or augmentation by AI technologies.

At step 214, the occupation taxonomy may be mapped to a set of AI impact queries. This mapping may identify relevant tasks for each occupation within a client's workforce. Step 214 may further map activities/tasks against a set of AI impact queries from a decision tree logic. The mapping process may involve semantic alignment between different ontologies (e.g., ONET based AI impact ontologies, etc.) for cross-referencing occupational data. The semantic alignment may enable the system to correlate functional roles and business processes with standardized occupational tasks, creating a comprehensive framework for AI impact assessment.

At step 216, an AI impact evaluation may be conducted using the mapped taxonomy and impact queries. This step may evaluate work activities/tasks against decision tree queries. An LLM (Large Language Model) may be applied to answer the set of queries. The evaluation may utilize an advanced Retrieval Augmented Generation (RAG) LLM approach with knowledge graphs and ontologies for factual responses. The advanced RAG LLM approach may analyze task characteristics including repeatability, data usage patterns, human collaboration requirements and specialized knowledge needs to determine AI suitability for each occupational task.

At step 218, a classification of AI impact may be applied based on the evaluation results. Using responses to the set of AI impact queries, each task may be classified by an AI impact classification. The classification may categorize tasks into impact levels such as high augmentation, high automation, moderate augmentation, slight augmentation or no impact. The classification system may provide a structured framework for understanding how different types of work activities may be affected by AI implementation. Other classifications and variations may be applied.

At step 220, an output may be customized to represent actual activities of a client workforce job. The customization step may adapt the standardized occupational data to reflect the specific tasks and responsibilities performed within a client's organizational context. In some cases, the customization may involve selecting the most relevant tasks from the occupation taxonomy and adjusting impact scores based on actual job requirements and organizational workflows.

At step 222, AI impact analysis may be customized for each client's unique workforce. The customization may involve mapping client-specific job roles to the most appropriate ONET occupations and selecting relevant tasks that align with actual job responsibilities. The customized analysis may provide organization-specific insights that reflect the particular work environment, technology infrastructure and operational requirements of each client.

At step 224, a recommendation may be generated and then implemented based on the customized AI impact analysis. The recommendations may include strategic workforce planning guidance, identification of high-priority areas for AI adoption and specific implementation pathways for automation and augmentation opportunities. The implementation phase may involve pilot programs, training and development initiatives and ongoing monitoring to assess the effectiveness of AI integration strategies within the client's workforce.

An embodiment of the present invention is directed to generating a recommendation as a structured approach for AI impact analysis focusing on workforce tasks, leveraging an Occupation Taxonomy, e.g., General Work Activities (GWA), Intermediate Work Activities (IWA), Detailed Work Activities (DWA), and Tasks Taxonomy for ONET Occupations. This methodology may be designed to help clients better understand how AI, specifically Large Language Models (LLMs), may automate and/or augment existing job roles within their organization.

By applying the recommended methodology for AI impact analysis using the ONET taxonomy, users may strategically identify areas within their workforce where AI can have the most significant impact. This approach enhances operational efficiency through automation and leverages AI to augment human capabilities, thereby fostering an innovative, competitive, and resilient organization. A key to this objective is the reuse of the continuously managed and evolving ONET Occupation Taxonomy and its use for creating a baseline ONET Occupation AI Impact dataset. This in turn is then customized at a detailed level to accurately represent the actual activities of a client's workforce job. The result is a customized AI Impact Analysis for each client's unique workforce. The advanced methodology provides a level of explainability beyond just ONET occupation and job matching, but rather at a more detailed explainable job activity level. The approach using ontologies and knowledge graphs enable expansion and alignment with other client operations data providing even more value for the use of this analysis.

Dynamic tracking of changes may be achieved by various methods, e.g., use of Lightcast Taxonomies and datasets (e.g., 35,000 skills and occupation taxonomy, and 72,000 Titles and by Patent Matching with ONET Tasks).

An embodiment of the present invention integrates a structured decision tree logic to classify each Task with ONET's comprehensive database of job activities and tasks. The decision tree categorizes potential AI impacts into a set of classifications, e.g., Highly Automated, Highly Augmented, Moderately Augmented, and Slight Augmentation or Non-Impact, based on specific characteristics of work activities such as data analysis, routine tasks, creativity requirement, human interaction augmentation, or specialized knowledge. An ONET baseline may be created, then a customized version may be created unique to a client.

An embodiment of the present invention is directed to an Impact Analysis Process and ONET Base Line AI Impact Analysis. This may involve mapping the ONET Taxonomy to AI Impact questions or queries. For example, this may begin by identifying relevant GWA, IWA, DWA, and Tasks for each occupation within the client's workforce. Then, these activities and tasks may be mapped against a set of AI Impact questions or queries derived from a decision tree logic.

For each occupation, conducting the AI Impact Evaluation may involve evaluating associated work activities and tasks against the decision tree queries. This evaluation may be done by experts or through a consultative process with job incumbents to ensure accuracy and may be initially created using an Advanced LLM RAG approach to answer these queries.

Classification of AI Impact may utilize the answers from the AI Impact queries to classify each task according to AI Impact Classifications (e.g., Highly Automated, Highly Augmented, Moderately Augmented, and Slight Augmentation or Non-Impact). This may highlight which areas of work are most susceptible to automation or augmentation by AI technologies.

An embodiment of the present invention is directed to a Client Workforce AI Impact Analysis Process and Customized ONET AI Impact Analysis. This may involve customizing a selected workforce job role to highest matching ONET occupation, and then selecting most relevant Tasks to actual job role. This customization may be used to roll-up the customized Task Level AI Impact scores to the Work Force Job role as was done for an ONET AI Impact baseline.

An embodiment of the present invention is directed to generating recommendations for Post-Analysis Actions. For Highly Automated Tasks, this may involve investigating and implementing AI solutions that can fully automate these tasks. This frees up human resources to focus on more complex, creative, or more human interaction driven activities.

For Highly and Moderately Augmented Tasks, this may involve exploring AI tools that support and enhance human performance in these areas. Training and development programs may be updated to include the use of these AI tools. Specific tasks to be augmented may be identified from AI Impact Knowledge System.

For Tasks with Slight Augmentation or Non-Impact, these areas for developments in AI capabilities may continue to be monitored. An embodiment of the present invention seeks to invest in human capital within these roles, as they represent activities where human intuition and creativity are irreplaceable. The tasks for these job roles that are highly dependent on human, rather than AI capabilities, may be identified.

Implementing the Recommendations may involve AI integration in selected roles or departments, focusing on “Highly Automated” tasks and evaluating performance improvements and scalability options.

Training and Development may involve aligning training programs to equip employees with the necessary skills for working alongside AI in “Highly Augmented” and “Moderately Augmented” areas.

Continuous Monitoring and Evaluation may involve establishing a continuous improvement process to monitor the impact of AI on workforce tasks, adapting strategies as AI technologies evolve and as organizational changes occur.

An embodiment of the present invention accounts for shifting occupations and skills to identify changes to a role over time by tracking client workforce with feedback and periodic incremental workforce updates. For example, the system may track ONET updates periodically, e.g., quarterly, annually, etc., exploring patents, crowd-sourced, and third-party data for insights on occupation changes.

An embodiment of the present invention may implement a model that introduces a detailed multi-level taxonomy linked to functional roles and business value factors (e.g., Functional Role Aligns with ONET AI Impact Analysis, Potential Effect on Success criteria, Accountability, and Operations Interactions across Functions, etc.) enhancing AI impact potential use for Functional Roles and Processes.

An embodiment of the present invention may relate function, roles and processes in the model to ONET tasks and use a computational model to then assess the impact of AI on the processes. Semantic alignment between the model and ONET Based AI Impact ontologies allows for AI impact analysis on processes, and leveraging functional roles. For example, a primary anchor may be between Functional Roles and ONET Occupation, then ONET Tasks and Processes.

Models may be extended and new models may be created to assess AI tools and their impact on tasks and be able to recommend AI tools to a client. This is feasible with an AI Technology Ontology describing the capabilities of the AI Tool and its support for an ONET Task, aligned using an advanced RAG LLM. ONET offers a Technology Skills element directly related to Occupations. An embodiment of the present invention may use a connector to data sources and alignment with Ontology concepts to associate with occupations, roles, tasks, etc.

Other implementations may be applied by changing an AI Impact Ontology to account for the provenance or source of the AI Impact on the ONET Tasks. Current impact classifications and scoring logic may be related to classifications focused on Augmentation or Automation which infer productivity enhancements due to technology use.

ONET Baseline AI Impact may be aggregated to a set of category levels to enable initial assessment of company potential for engagement for AI Impact. Other ontologies may be integrated with the various embodiments of the present invention. For example, ontology alignment between ONET and Workaday Skill Cloud Ontology may be applied. Data entities may be aligned with an Advanced LLM through connectors to actual data sets, cloud data, and applications data.

An embodiment of the present invention is directed to a computation model to process client data to provide a comprehensive AI opportunity scorecard and other valuable outputs.

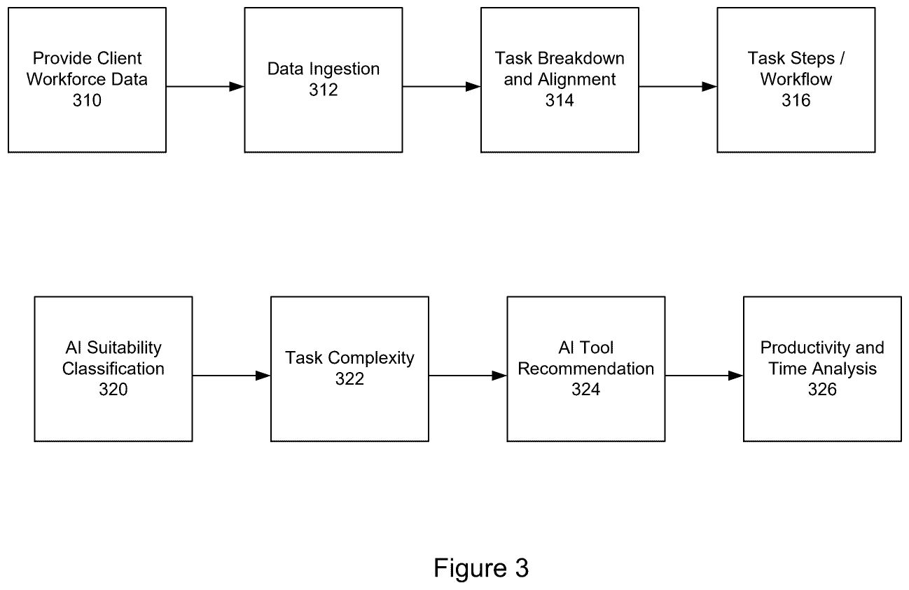

FIG. 3 is an exemplary flow diagram, according to an embodiment of the present invention. At step 310, client workforce data may be provided. At step 312, data ingestion may be performed. At step 314, task breakdown and alignment may be performed. At step 316, task steps/workflow may be identified. At step 320, AI suitability classification may be performed. At step 322, task complexity may be determined. At step 324, AI tool recommendation may be generated. At step 326, productivity and time analysis may be performed. While the process of FIG. 3 illustrates certain steps performed in a particular order, it should be understood that the embodiments of the present invention may be practiced by adding one or more steps to the processes, omitting steps within the processes and/or altering the order in which one or more steps are performed. Additional details for each step are provided below.

An AI model of an embodiment of the present invention may process client data to provide a comprehensive AI opportunity scorecard and other valuable outputs.

At step 310, client workforce data may be provided. For example, a client may provide specific workforce context (e.g., job titles, descriptions, etc.) to indicate the nature of work completed and day-to-day tasks. The client workforce data may include job titles, job descriptions, organizational structure information, and specific workforce context that indicates the nature of work completed and day-to-day tasks performed by employees within the organization.

At step 312, data ingestion may be performed. Client workforce data may be processed and cleared for possible errors that may occur during the analysis. For example, data ingestion may involve data validation, format standardization and quality assurance procedures to ensure the workforce information is suitable for automated processing and analysis.

At step 314, task breakdown and alignment may be performed. An embodiment of the present invention may index job descriptions into tasks, aligning them with the underlying ontology and classify tasks as expertise, human collaboration or routine.

At step 316, task steps/workflow may be identified. The tasks may be broken down into steps to complete a task or workflow. The task breakdown may create granular step-by-step procedures that define how individual tasks are executed within the client's organizational context. In some cases, the system may leverage target operating models for task and step identification within workflows, providing structured frameworks that define operational processes and functional relationships across different business areas.

At step 320, AI suitability classification may be performed using multi-factor task evaluation. An embodiment of the present invention may evaluate the ability for each step within a task to be automated or augmented with AI or not suitable for AI. This may involve assessing repeatability, use of data, human collaboration and need for specialized knowledge or skills.

At step 322, task complexity may be assessed to provide additional context for AI implementation planning. Tasks may be classified by complexity and evaluated for AI suitability. The complexity assessment may consider factors such as decision-making requirements, variability in execution and interdependencies with other organizational processes.

At step 324, AI tool recommendation may be generated based on the suitability classification and complexity assessment results. During AI tool recommendation, the platform may map tasks to the most appropriate AI tools based on the characteristics and requirements identified during the analysis process. The mapping process may consider the specific capabilities of available AI technologies and match them with the particular needs and constraints of each identified task or workflow step.

At step 326, productivity and time analysis may be performed to quantify the potential benefits of AI implementation. An embodiment of the present invention may calculate potential productivity gains and time savings and assign a monetary value. Time saved and other efficiencies by AI augmentation may be aggregated and totaled across some or all analyzed tasks to provide comprehensive organizational impact projections for workforce transformation initiatives.

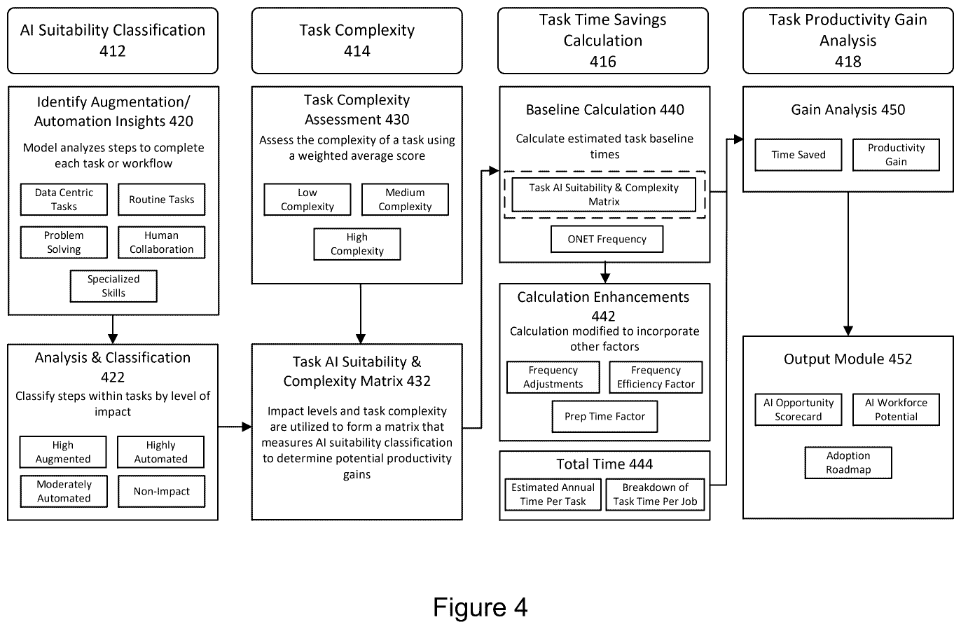

FIG. 4 is an exemplary illustration of an AI model, according to an embodiment of the present invention. AI Model may support AI Suitability Classification 412; Task Complexity 414; Task Time Savings Calculation 416; and Task Productivity Gain Analysis 418.

AI Suitability Classification 412 may support Identify Augmentation/Automation Insights 420 and Analysis and Classification 422.

With Identify Augmentation/Automation Insights 420, the AI model analyzes steps to complete each task or workflow, as shown by Datacentric Tasks, Routine Tasks, Problem Solving, Human Collaboration and Specialized Skills. Identify Augmentation/Automation Insights 420 may identify different categories of work activities based on their operational characteristics and requirements. For example, Identify Augmentation/Automation Insights 420 may categorize tasks as data centric tasks that involve processing, analyzing or manipulating information resources. The module may also identify routine tasks that follow predictable patterns and standardized procedures, problem solving tasks that require analytical thinking and decision-making capabilities, human collaboration tasks that involve interpersonal interaction and coordination activities, and specialized skills tasks that demand domain-specific expertise or technical knowledge.

Analysis and Classification 422 may classify steps within tasks by level of impact, as shown by High Augmented, Highly Automated, Moderately Automated, and Non-Impact. Analysis and Classification 422 may evaluate the categorized tasks and assign impact classifications that reflect the degree to which AI technologies may enhance or transform specific work activities. Analysis and Classification 422 may classify tasks into categories including high augmented tasks where AI may substantially enhance human capabilities, highly automated tasks where AI may perform work activities with minimal human intervention, moderately automated tasks where AI may provide moderate assistance or efficiency improvements, and non-impact tasks where AI implementation may provide little or no benefit to current work processes.

Task Complexity 414 may support Task Complexity 430 and Task AI Suitability and Complexity Matrix 432.

Task Complexity Assessment 430 may assess the complexity of a task using a weighted average score, as shown by Low Complexity, Medium Complexity and High Complexity. Task Complexity Assessment 430 may evaluate tasks across multiple complexity dimensions and may classify work activities into complexity levels including low complexity tasks that involve straightforward procedures and minimal decision-making requirements, medium complexity tasks that require moderate analytical thinking and procedural knowledge, and high complexity tasks that demand advanced expertise, complex reasoning, or sophisticated problem-solving capabilities.

With Task AI Suitability and Complexity Matrix 432, impact levels and task complexity may be utilized to form a matrix that measures AI suitability classification to determine potential productivity gains. Task AI Suitability and Complexity Matrix 432 may provide a structured framework for correlating AI impact potential with task complexity levels. Task AI Suitability and Complexity Matrix 432 may receive input from Analysis and Classification 422 and Task Complexity Assessment 430, forming a comprehensive evaluation matrix that measures AI suitability classification against impact levels and task complexity dimensions. In some cases, Task AI Suitability and Complexity Matrix 432 may enable the generation of nuanced recommendations that consider the potential for AI enhancement and the complexity challenges associated with implementing AI solutions for specific types of work activities.

Task Time Savings Calculation 416 may support Baseline Calculation 440, Calculation Enhancements 442 and Total Time 444. Task Time Savings Calculation 416 may quantify the temporal benefits achievable through AI implementation across different workforce activities. For example, Task Time Savings Calculation 416 may provide comprehensive time-based analysis capabilities that enable organizations to understand the potential efficiency gains from AI integration initiatives. In addition, Task Time Savings Calculation 416 may work in conjunction with Task AI Suitability and Complexity Matrix 432 to generate accurate time savings projections based on AI impact potential and task complexity characteristics.

Baseline Calculation 440 may calculate estimated task baseline times, as shown by Task AI Suitability and Complexity Matrix and ONET Frequency. Baseline Calculation 440 may calculate estimated task baseline times using standardized temporal measurement methodologies. Baseline Calculation 440 may utilize Task AI Suitability and Complexity Matrix 432 and ONET frequency data to establish foundational time estimates for various work activities within client organizations. For example, Baseline Calculation 440 may incorporate occupational frequency data from ONET to reflect how often specific tasks are performed within different job roles, providing realistic baseline measurements that account for actual workplace task distribution patterns.

Calculation Enhancements 442 may support calculations modified to incorporate various other factors as shown by Frequency Adjustments, Frequency Efficiency Factor and Prep Time Factor. Calculation Enhancements 442 may modify the baseline calculations to incorporate additional factors that affect actual task completion times. For example, Calculation Enhancements 442 may also apply a frequency efficiency factor that reflects how task repetition may influence completion times and may incorporate a prep time factor that accounts for setup, preparation, and transition activities associated with task execution.

Total Time 444 may generate estimated annual time per task and breakdown of task time per job. Total Time 444 may provide comprehensive temporal analysis outputs for workforce planning purposes. For example, Total Time 444 may generate estimated annual time per task calculations that project the total time investment for specific work activities over yearly periods. Total Time 444 may also provide breakdown of task time per job analysis that distributes temporal requirements across different job roles and organizational positions, enabling detailed workforce capacity planning and resource allocation strategies. Other time analytics and time periods may be applied.

Task Productivity Gain Analysis 418 may include Gain Analysis 450 and Output Module 452.

Task Productivity Gain Analysis 418 may evaluate the performance improvements achievable through AI implementation across analyzed workforce activities. Task Productivity Gain Analysis 418 may transform the time savings calculations into comprehensive productivity metrics that quantify the business value of AI integration initiatives. For example, Task Productivity Gain Analysis 418 may receive input from Total Time 444 to generate productivity assessments based on the calculated time savings and efficiency improvements.

Gain Analysis 450 may include Time Saved and Productivity Gain. Gain Analysis Module 450 may calculate time saved and productivity gain metrics for individual tasks and aggregate organizational activities. Gain Analysis Module 450 may process the temporal data from Total Time 444 to determine the specific time savings achievable through AI augmentation or automation of identified work activities. For example, Gain Analysis 450 may calculate productivity gain metrics that translate time savings into quantifiable business benefits, including efficiency improvements, capacity increases and resource optimization opportunities.

Output 452 may include AI Opportunity Scorecard, AI Workforce Potential and Adoption Roadmap. Output Module 452 may generate comprehensive analysis outputs that support strategic workforce transformation decision-making. For example, Output Module 452 may produce an AI opportunity scorecard that provides a structured assessment of AI implementation potential across different organizational areas, roles, and tasks. Output Module 452 may also generate AI workforce potential analysis that identifies the most promising opportunities for AI integration within the client's specific workforce context. Additionally, Output Module 452 may create an adoption roadmap that provides strategic guidance for implementing AI technologies in a phased approach that maximizes benefits while minimizing organizational disruption.

An embodiment of the present invention is directed to an AI-Human collaboration or AI Coach. This may involve delivering AI learning at the moment of the task to accelerate the impact of AI for the organization and employees. The AI Coach provides personalized experiences that reflect a deep understanding of the employees'work and potential for growth and seamlessly incorporates generative AI into their workflows, empowering employees to apply AI to their everyday tasks. With the AI Coach, dynamic upskilling initiatives may evolve with the workforce's proficiency and AI advancements.

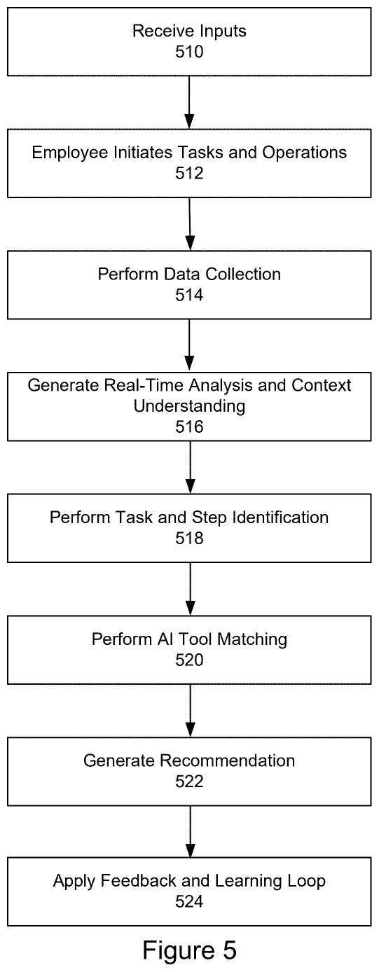

FIG. 5 is an exemplary flow diagram, according to an embodiment of the present invention. At step 510, inputs may be received. At step 512, an employee may start/continue working. At step 514, data collection may be performed. At step 516, real-time analysis and context understanding may be provided. At step 518, task and step identification may be performed. At step 520, AI Tool Matching may be provided. At step 522, recommendations may be generated. At step 524, a feedback and learning loop may be provided. While the process of FIG. 5 illustrates certain steps performed in a particular order, it should be understood that the embodiments of the present invention may be practiced by adding one or more steps to the processes, omitting steps within the processes and/or altering the order in which one or more steps are performed. Additional details for each step are provided below.

At step 510, inputs may be received. Inputs may include job descriptions and underlying tasks and steps to complete specific work activities within the employee's role. The inputs may also include employee motivations for using generative AI and current level of knowledge with AI tools to customize the assistance provided. For example, the inputs may include options for employees to specify particular tasks they need help with, which may involve natural language processing and contextual analysis capabilities within the platform.

At step 512, an employee may start/continue working within their normal workflow environment. During this phase, the employee may engage in regular work activities while the platform prepares to monitor and analyze the work context. For example, an employee experience subsystem may activate monitoring capabilities that enable the platform to observe work patterns and identify opportunities for AI assistance without disrupting the employee's natural workflow processes.

At step 514, data collection may be performed. Data collection may include various forms of passive data collection (e.g., telemetry data) as the employee works or interacts with various services and entities. The system may monitor actions, document types, application usage and other relevant metrics to understand the task context. Data collection may involve passive collection of telemetry data as the employee works, including monitoring of actions, document types, application usage and other relevant metrics to understand the task context. The platform may gather this information without requiring active input from the employee, enabling seamless integration of AI assistance capabilities into existing work processes. The data collection may capture workflow patterns, task execution sequences, and contextual information that informs subsequent analysis and recommendation generation.

At step 516, real-time analysis and context understanding may be generated. An embodiment of the present invention may perform real-time analysis to understand the work context, task objectives, and patterns in an employee's workflow. The real-time analysis may involve processing the monitored work activities to understand the work context, task objectives, and patterns in the employee's workflow. The platform may perform contextual analysis that identifies the current work situation, determines the employee's immediate needs, and assesses opportunities for AI assistance. In some cases, the real-time analysis may incorporate machine learning algorithms that adapt to individual work patterns and improve context understanding over time.

At step 518, task and step identification may be performed. An embodiment of the present invention may identify the task including steps to complete the task or workflow. Other relevant data may include relative complexity and specific needs based on workflow patterns. Target Operating Models may be implemented. The task and step identification may involve identifying specific tasks including steps to complete the task or workflow, complexity levels, and specific needs based on observed workflow patterns. The platform may leverage target operating models during task and step identification to provide structured frameworks for understanding operational processes and functional relationships within the employee's work context.

At step 520, AI Tool Matching may be provided. An embodiment of the present invention may match the identified steps within a task with the most suitable AI tools (including Generative AI and other tools) based on capabilities and what the user's enterprise has licensed. The AI tool matching may involve matching the identified steps within a task with the most suitable AI tools based on tool capabilities and what the user's enterprise has licensed. The matching process may consider the specific functionality requirements of each task step and correlate these requirements with the capabilities of available AI tools within the organization's technology infrastructure. For example, the AI tool matching may account for enterprise licensing constraints to ensure that recommended tools are accessible and approved for use within the organizational environment.

At step 522, recommendations may be generated. An embodiment of the present invention may break down the task into steps for the employee to help them understand how to incorporate AI tools. For example, the platform may provide hyper-personalized recommendations that help employees integrate AI tools into their work in real-time with specific prompts and learning integration. The recommendations may include specific prompts that employees can use in AI tools, along with explanations of how to use the recommended tools effectively within their particular work context.

At step 524, a feedback and learning loop may be provided. An embodiment of the present invention may gather user feedback and outcomes to refine future recommendations. The feedback and learning loop may involve gathering user feedback and outcomes to refine future recommendations and improve the accuracy of AI tool matching and task identification processes. The feedback loop may collect information about the effectiveness of provided recommendations, user satisfaction with suggested AI tools, and outcomes achieved through AI integration. For example, the feedback and learning loop may enable the platform to adapt its recommendation algorithms based on observed user behavior and measured performance improvements, creating a self-improving system that becomes more effective over time.

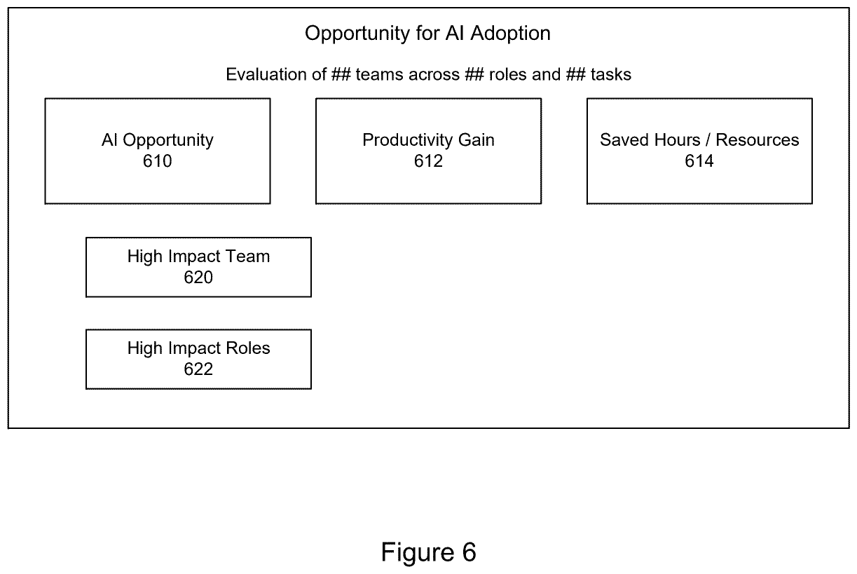

FIG. 6 is an exemplary user interface, according to an embodiment of the present invention. FIG. 6 illustrates a user interface that presents evaluation metrics in a structured layout that facilitates comprehensive analysis of AI adoption potential. In the upper portion of the interface, the user interface may display primary metrics that quantify overall AI implementation opportunities and benefits.

As shown in FIG. 6, user interface details an opportunity for AI Adoption based on an evaluation of a number of teams, across a number of roles and a number of tasks, as shown by AI Opportunity 610, Productivity Gain 612, Saved Resources 614, High Impact Team 620 and High Impact Roles 622.

The exemplary user interface presents comprehensive evaluation metrics for AI adoption opportunities across teams, roles and tasks within client organizations. The display interface may serve as a centralized dashboard that enables stakeholders to assess workforce transformation potential through quantified metrics and visual representations of AI implementation opportunities. The interface may present multiple evaluation dimensions simultaneously, allowing users to understand the scope and impact of potential AI integration initiatives across different organizational levels.

AI Opportunity 610 may represent a percentage (or other measure) of employees across a number of roles with a potential to have a savings of resources for a number of tasks. AI Opportunity 610 may indicate the total AI opportunity assessment value, representing the aggregate potential for AI integration across the analyzed workforce. AI Opportunity 610 may synthesize data from workforce shaping subsystem to provide a comprehensive score that reflects the overall readiness and potential for AI adoption within the client organization.

Productivity Gain 612 may represent a gain resulting from employees collaborating with AI to perform their jobs faster thereby freeing up time for other valuable work. Productivity Gain 612 quantifies the potential productivity improvements achievable through AI implementation. Productivity Gain 612 may present calculated values derived from gain analysis module and may represent the measurable performance enhancements that the organization may achieve through strategic AI integration. Productivity Gain 612 may incorporate time savings, efficiency improvements, and capacity increases identified during the workforce analysis process.

Saved Resources 614 demonstrates an amount of resources (e.g., hours) that can be saved by augmenting employees across a workforce. Saved Resources 614 shows the estimated time savings or resource conservation achievable through AI implementation across the analyzed workforce. Saved Resources 614 may display aggregated time savings calculated by total time calculation module and may represent the cumulative temporal benefits that may result from AI augmentation and automation of identified tasks and workflows. Saved Resources 614 may provide stakeholders with concrete measurements of efficiency gains that may be realized through workforce transformation initiatives.

High Impact Team 620 identifies team details with a high impact of productivity gain. High Impact Team 620 may identify teams that would benefit most from AI adoption based on the analysis performed by the platform. High Impact Team 620 may present data processed by workforce optimization subsystem to highlight specific organizational units, departments, or functional groups that demonstrate the greatest potential for productivity improvements through AI integration.

High Impact Roles 622 identifies role details within a team having a high impact. High Impact Roles metric 622 highlights specific roles within the organization that have the highest potential for AI-driven transformation. High Impact Roles 622 may display analysis results from AI suitability classification module and the analysis classification module to identify job positions, functional roles, or occupational categories that may achieve substantial benefits through AI implementation. High Impact Roles 622 may enable targeted workforce transformation strategies that focus resources on the most promising opportunities for AI integration.

The display interface may enable stakeholders to assess the business case for AI implementation through quantified metrics that translate technical analysis results into actionable business intelligence. The interface may support strategic decision-making by presenting both aggregate opportunity assessments and granular insights about specific organizational areas that may benefit from AI integration. In some cases, the display interface may serve as a communication tool that enables organizations to present workforce transformation opportunities to leadership, stakeholders, and employees in a clear and quantifiable format.

An embodiment of the present invention provides technical improvements to computer functionality through specialized data processing architectures and algorithms that address specific computational challenges in workforce analysis and AI integration. An embodiment of the present invention may implement distributed computing architectures that enable real-time processing of large-scale workforce datasets while maintaining system responsiveness and data integrity. The technical implementation may involve specialized data structures and indexing mechanisms that optimize query performance when analyzing complex relationships between job tasks, skill requirements, and AI tool capabilities across diverse organizational contexts.

As discussed above, workforce shaping subsystem 132 may utilize advanced natural language processing algorithms specifically configured to decompose unstructured job description text into structured task taxonomies that can be computationally analyzed for AI suitability. An embodiment of the present invention may implement machine learning models that are trained on occupational data patterns to automatically classify work activities according to their automation and augmentation potential, reducing computational overhead compared to manual classification approaches. The technical implementation may include specialized scoring algorithms that process multiple task characteristics simultaneously to generate quantitative AI impact assessments that would be impractical to calculate manually.

An embodiment of the present invention may implement real-time data collection and analysis capabilities through specialized monitoring agents that capture telemetry data from employee work activities without degrading system performance. As discussed above, employee experience subsystem 138 may utilize event-driven architectures that enable immediate response to workflow changes and task transitions, providing contextual AI recommendations with minimal latency. The system may implement caching mechanisms and predictive loading strategies that anticipate user needs and pre-process AI tool recommendations to improve response times during active work sessions.

The digital skills wallet 136 may implement cryptographic verification mechanisms and distributed ledger technologies that provide tamper-proof credential storage while enabling efficient verification processes. The technical implementation may include specialized data synchronization protocols that maintain consistency across multiple data stores 152 and 154 while supporting concurrent access from multiple subsystems. The platform may utilize graph database structures to model complex relationships between skills, tasks, and AI tools, enabling efficient traversal and analysis of workforce transformation pathways that would be computationally intensive using traditional relational database approaches.

It will be appreciated by those persons skilled in the art that the various embodiments described herein are capable of broad utility and application. Accordingly, while the various embodiments are described herein in detail in relation to the exemplary embodiments, it is to be understood that this disclosure is illustrative and exemplary of the various embodiments and is made to provide an enabling disclosure. Accordingly, the disclosure is not intended to be construed to limit the embodiments or otherwise to exclude any other such embodiments, adaptations, variations, modifications and equivalent arrangements.

The foregoing descriptions provide examples of different configurations and features of embodiments of the invention. While certain nomenclature and types of applications/hardware are described, other names and application/hardware usage is possible and the nomenclature is provided by way of non-limiting examples only. Further, while particular embodiments are described, it should be appreciated that the features and functions of each embodiment may be combined in any combination as is within the capability of one skilled in the art. The figures provide additional exemplary details regarding the various embodiments.

Various exemplary methods are provided by way of example herein. The methods described can be executed or otherwise performed by one or a combination of various systems and modules.

The use of the term computer system in the present disclosure can relate to a single computer or multiple computers. In various embodiments, the multiple computers can be networked. The networking can be any type of network, including, but not limited to, wired and wireless networks, a local-area network, a wide-area network, and the Internet.

According to exemplary embodiments, the System software may be implemented as one or more computer program products, for example, one or more modules of computer program instructions encoded on a computer-readable medium for execution by, or to control the operation of, data processing apparatus. The implementations can include single or distributed processing of algorithms. The computer-readable medium can be a machine-readable storage device, a machine-readable storage substrate, a memory device, or a combination of one or more them. The term “processor” encompasses all apparatus, devices, and machines for processing data, including by way of example a programmable processor, a computer, or multiple processors or computers. The apparatus can include, in addition to hardware, software code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

A computer may encompass all apparatus, devices, and machines for processing data, including by way of example a programmable processor, a computer, or multiple processors or computers. It can include, in addition to hardware, code that creates an execution environment for the computer program in question, e.g., code that constitutes processor firmware, a protocol stack, a database management system, an operating system, or a combination of one or more of them.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computer-readable media suitable for storing computer program instructions and data can include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While the embodiments have been particularly shown and described within the framework for conducting analysis, it will be appreciated that variations and modifications may be affected by a person skilled in the art without departing from the scope of the various embodiments. Furthermore, one skilled in the art will recognize that such processes and systems do not need to be restricted to the specific embodiments described herein. Other embodiments, combinations of the present embodiments, and uses and advantages will be apparent to those skilled in the art from consideration of the specification and practice of the embodiments disclosed herein. The specification and examples should be considered exemplary.

What is claimed is:

1. A computer-implemented system for workforce transformation and AI-enabled skill development platform, comprising:
a workforce transformation platform configured to receive workforce data from at least one client organization, wherein the workforce data comprises job titles, job descriptions and task information for employees within the at least one client organization;
a workforce shaping subsystem configured to analyze the workforce data by decomposing the job descriptions into constituent tasks and aligning the tasks with a skills ontology that categorizes work activities according to their suitability for artificial intelligence automation or augmentation, and to classify each task based on a set of factors comprising repeatability, data utilization requirements, human collaboration needs and specialized knowledge requirements;
a workforce optimization subsystem configured to generate personalized career development pathways for individual employees based on AI impact analysis of their current roles and identified skill gaps; and
a digital skills wallet configured to store and manage employee credentials, achievements, and verified competencies in a portable format;
wherein the platform is configured to generate an AI opportunity scorecard that identifies roles, tasks, and organizational areas with an optimal potential for AI-driven productivity improvements, and to calculate monetary values associated with potential time savings and productivity gains from AI implementation.

2. The computer-implemented system of claim 1, wherein the skills ontology is based on occupational data from standardized databases including ONET occupational classifications and work activity taxonomies.

3. The computer-implemented system of claim 1, wherein the workforce shaping subsystem utilizes machine learning algorithms to continuously update AI impact assessments based on evolving AI tool capabilities and workplace implementation data.

4. The computer-implemented system of claim 1, further comprising an AI tool recommendation engine configured to match specific tasks with appropriate AI tools based on task characteristics and organizational technology infrastructure.

5. The computer-implemented system of claim 4, wherein the AI tool recommendation engine provides step-by-step guidance for AI tool implementation including specific prompts, configuration instructions, and integration workflows.

6. The computer-implemented system of claim 1, wherein the workforce optimization subsystem provides real-time coaching and guidance to employees during task execution, delivering contextual recommendations for AI tool integration.

7. The computer-implemented system of claim 6, wherein the real-time coaching utilizes passive data collection techniques including application usage monitoring, document interaction tracking, and workflow pattern analysis to understand employee work contexts.

8. The computer-implemented system of claim 1, wherein the digital skills wallet utilizes blockchain or distributed ledger technology to provide tamper-proof verification of employee competencies and achievements.

9. The computer-implemented system of claim 1, wherein the AI opportunity scorecard includes visualizations showing productivity potential across different organizational levels, departments, and individual roles.

10. The computer-implemented system of claim 1, further comprising feedback mechanisms that capture employee interactions with AI tools to refine future recommendations and improve accuracy of productivity calculations.

11. A computer-implemented method for workforce transformation and AI-enabled skill development, comprising the steps of:
receiving, via a workforce transformation platform, workforce data from at least one client organization, wherein the workforce data comprises job titles, job descriptions and task information for employees within the at least one client organization;
analyzing, via a workforce shaping subsystem, the workforce data by decomposing the job descriptions into constituent tasks and aligning the tasks with a skills ontology that categorizes work activities according to their suitability for artificial intelligence automation or augmentation, and to classify each task based on a set of factors comprising repeatability, data utilization requirements, human collaboration needs and specialized knowledge requirements;
generating, via a workforce optimization subsystem, personalized career development pathways for individual employees based on AI impact analysis of their current roles and identified skill gaps;
storing and managing, via a digital skills wallet, employee credentials, achievements, and verified competencies in a portable format; and
generating an AI opportunity scorecard that identifies roles, tasks, and organizational areas with an optimal potential for AI-driven productivity improvements, and to calculate monetary values associated with potential time savings and productivity gains from AI implementation.

12. The computer-implemented method of claim 11, wherein the skills ontology is based on occupational data from standardized databases including ONET occupational classifications and work activity taxonomies.

13. The computer-implemented method of claim 11, wherein the workforce shaping subsystem utilizes machine learning algorithms to continuously update AI impact assessments based on evolving AI tool capabilities and workplace implementation data.

14. The computer-implemented method of claim 11, further comprising the step of:
matching, via an AI tool recommendation engine, specific tasks with appropriate AI tools based on task characteristics and organizational technology infrastructure.

15. The computer-implemented method of claim 14, wherein the AI tool recommendation engine provides step-by-step guidance for AI tool implementation including specific prompts, configuration instructions, and integration workflows.

16. The computer-implemented method of claim 11, wherein the workforce optimization subsystem provides real-time coaching and guidance to employees during task execution, delivering contextual recommendations for AI tool integration.

17. The computer-implemented method of claim 16, wherein the real-time coaching utilizes passive data collection techniques including application usage monitoring, document interaction tracking, and workflow pattern analysis to understand employee work contexts.

18. The computer-implemented method of claim 11, wherein the digital skills wallet utilizes blockchain or distributed ledger technology to provide tamper-proof verification of employee competencies and achievements.

19. The computer-implemented method of claim 11, wherein the AI opportunity scorecard includes visualizations showing productivity potential across different organizational levels, departments, and individual roles.

20. The computer-implemented method of claim 11, further comprising the step of:
capturing, via a feedback mechanism, employee interactions with AI tools to refine future recommendations and improve accuracy of productivity calculations.
